(19) United States
(12) Patent Application Publication
(10) Pub. No.: US 2007/0206649 A1
(43) Pub. Date: Sep. 6, 2007

(54) HIGH REPETITION RATE LASER MODULE

(75) Inventors: Baoxi Xu, Singapore (SG); Chong Wei Chuah, Singapore (SG); Tow Chong Chong, Singapore (SG)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: AGENCY FOR SCIENCE, TECHNOLOGY AND RESEARCH, Centros (SG)

(21) Appl. No.: 11/682,116

(22) Filed: Mar. 5, 2007

Related U.S. Application Data
(60) Provisional application No. 60/778,391, filed on Mar. 3, 2006.

(51) Int. Cl. H01S 3/00

(52) U.S. Cl. 372/38.02

(57) ABSTRACT

A laser module includes an electrical connector; a laser diode coupled to the electrical connector through a transmission line; and an optical coupler in optical communication with an optical output of the laser diode. A matching impedance is connected in series with the laser diode, downstream of the laser diode, for providing an electrical impedance matched to a signal generator for driving the laser diode.

### CROSS-REFERENCE TO RELATED APPLICATIONS

This application claims benefits from U.S. Provisional Patent Application No. 60/778,391 filed Mar. 3, 2006, the contents of which are hereby incorporated herein by reference.

### FIELD OF THE INVENTION

The present invention relates generally to lasers, and more particularly to high frequency laser diode arrangements. In some embodiments, it relates to a semiconductor laser head structure with semiconductor laser diode for high repetition rate and ultra short pulse generation.

### BACKGROUND OF THE INVENTION

High repetition rate and ultra-short pulse semiconductor lasers have the advantages of being simple, small, consume relatively little power and may be formed at relatively low cost. With these advantages, there are numerous potential applications for such lasers.

For example, a very tiny spot of high repetitive ultra-short pulse laser may be used in magnetic recording, especially heat-assisted magnetic recording (HAMR), to achieve Tb/in² of area density in magnetic data storage. A laser spot heats the magnetic media. The heated magnetic media has lower coercivity relatively to ambient temperature magnetic media. A magnetic writer may readily change the polarities of the locally heated magnetic media during writing. Heating counteracts the super-paramagtism limitation in magnetic data storage. Moreover, the frequency (typically several GHz) of the repetitive pulse laser provides may be synchronized with high data rate transfer.

Another potential application is in bio-imaging microscopy. High repetitive ultra-short pulse lasers provide quasi-continuous wave (CW) light sources for confocal microscopes, instead of CW laser, to reduce the photo-bleaching effect at the living specimen. This extends the longevity of the specimen from while allowing observation under a confocal laser scanning microscope.

In short, with high repetitive ultra-short pulse laser, more applications in various fields are to be explored/triggered. Hence, there is a need to develop ultra-short pulse and high repetitive semiconductor laser source.

Accordingly, there is a need improved laser, operable to produce high repetitive, ultra short pulses.

### SUMMARY OF THE INVENTION

In accordance with an aspect of the present invention, there is provided a laser module, comprising: an electrical connector; a laser diode coupled to the electrical connector through a transmission line; a matching impedance connected in series with the laser diode for providing an electrical impedance matched to a signal generator for driving the laser diode; and an optical coupler in optical communication with an optical output of the laser diode.

In accordance with another aspect of the present invention, a laser module, comprises a metal sub-mount, comprising a generally bridge shaped mount; a laser diode mounted on the generally bridge shaped mount, an electrical connector, within the metal sub-mount; a transmission line extending along the bridged shape mount to interconnect the electrical connector to a first electrode of the laser diode; a conducting tab, extending from a second electrode of the laser diode, along the bridged shaped mount to a matching impedance; a matching impedance within the metal sub-mount, connected in series with the conducting tab for providing an electrical impedance matched to a signal generator for driving the laser diode; and an optical coupler in optical communication with an optical output of the laser diode.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1A is a cross sectional top view of a laser module according to a first embodiment of the present invention;

FIG. 1B is a cross sectional top view of a laser module, like the laser module of FIG. 1A, having two optical couplers, according to a second embodiment of the present invention;

FIG. 2 is an isometric view of profiled sub-mount of the laser diode module of FIG. 1;

FIG. 3 is showing the schematic diagram of electrical current driving of semiconductor laser head;

FIGS. 4A and 4B are diagrams showing the return loss (S11 curve) of commercial TO-CAN packaging and the laser diode module of FIG. 1A, respectively;

FIG. 5 is a cross sectional top view of a diode laser module according to a third embodiment of the present invention;

FIG. 6 is a cross sectional view of a TO-CAN packaging laser module modified, for use with the laser diode module of FIG. 5;

FIG. 7 is an isometric view of a profiled sub-mount in of the laser module of FIG. 5;

FIG. 8A is a graph showing measured pulse width at various repetition rate, and FIGS. 8B and 8C are graphs showing the pulse stream at 1.0 GHz and 2.0 GHz respectively, of the laser module of FIG. 1A with a violet laser diode;

FIG. 9A is a graph showing the measured pulse width at various repetition rate, and FIGS. 9B and 9C are graphs showing the pulse stream at 1.0 GHz and 2.0 GHz respectively, of the laser module of FIG. 1A with a red laser diode;

FIGS. 10 to 17 are cross sectional top views of laser modules, exemplary of additional embodiments of the present invention; and

FIGS. 18 and 19 are perspective views of example casings for the laser modules exemplary of embodiments of the present invention.

### DETAILED DESCRIPTION

Today, ultra-short semiconductor laser output is produced using two common methods: gain-switching and mode-locking. Gain-switching involves controlling a laser diode's gain by current modulation. Mode-locking involves controlling the laser diode's gain by phase modulation. Mode-locking generates laser outputs of shorter pulse width compared to gain-switching, but is much more unstable.

Commercially available TO-CAN packaged laser diodes may be driven with high frequency drivers. However, commercial TO-CAN packaged laser diodes have very low dynamic resistance: equal to only a few ohms of resistance when operating. Meanwhile, commercial high frequency sinusoidal generators or ultra-short current pulse generators typically have a 50Ω output impedance. By directly connecting the generator to the TO-CAN packaged laser diode, the impedance mismatch at the interface may cause the driving signal to be reflected back and scattered. This causes the generator output to be unstable and may further damage the generator. The inefficient transmission signal is dissipated as thermal energy through its transmission medium.

In addition, higher output power from the generator may be needed to pump the laser diode due to the impedance mismatching.

Exemplary of embodiments of the present invention, the electrical impedance of the laser is matched to the generator.

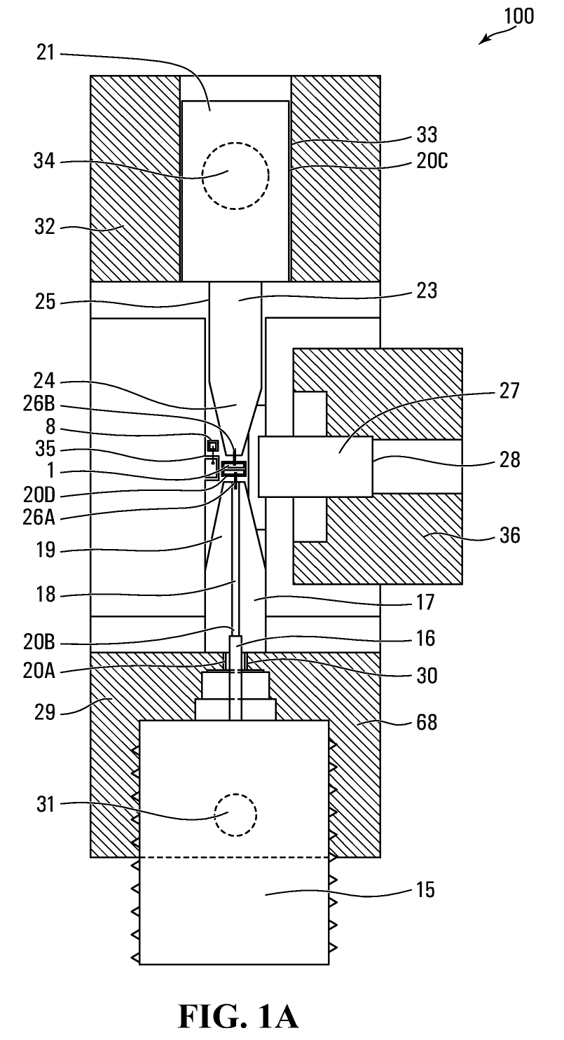

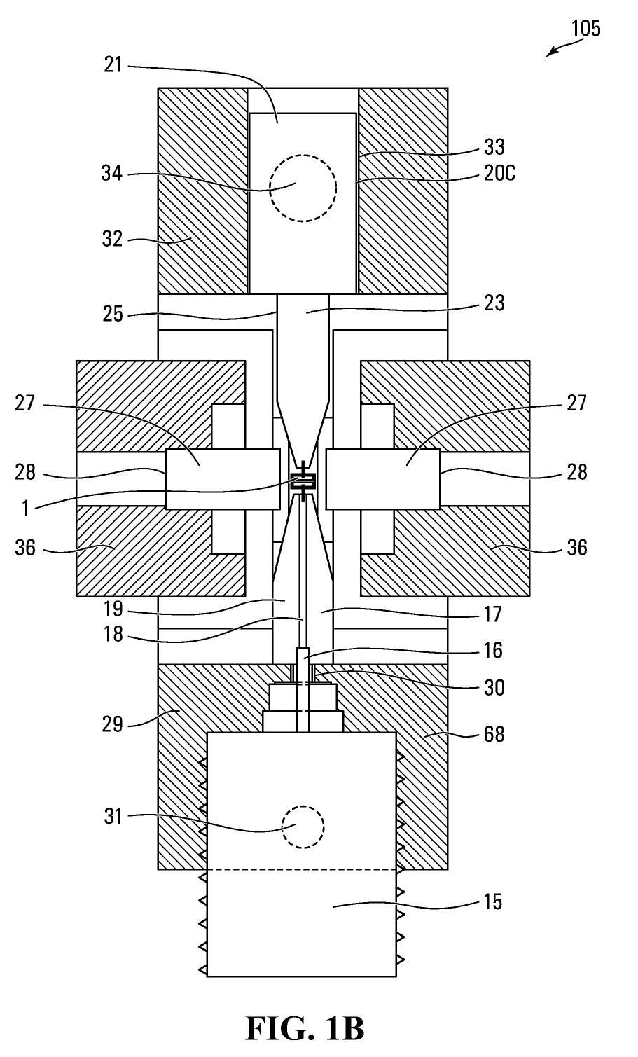

To this end, FIG. 1A is a cross sectional view of a laser module 100, exemplary of an embodiment of the present invention. Laser module 100 includes a profiled sub-mount 68 with electrical and optical components assembled thereon to form an optical system.

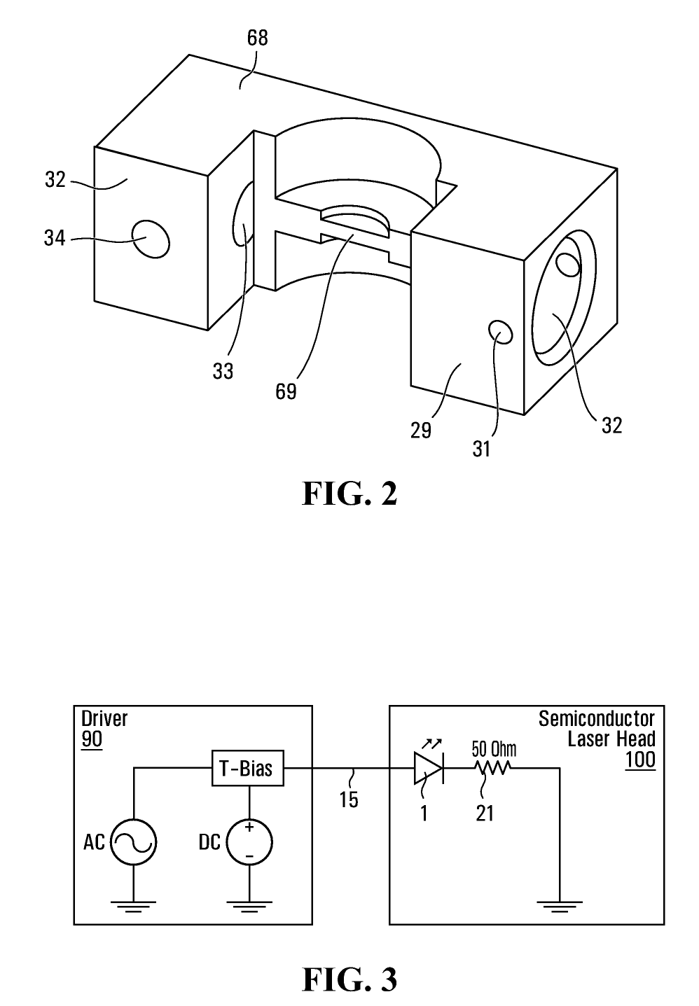

Sub-mount 68 without electrical components, is illustrated in FIG. 2. Sub-mount 68 is rectangular and has a U-shaped profile, as illustrated. Sub-mount 68 may be mechanically fabricated, substantially from metal, such as copper with gold-plated surfaces. A bridge-shaped center portion 69 accommodates a transmission line 17, a laser diode (LD) 1, an isolation stand-off 25 and a termination tab 23. Sidewalls 29, 32 at both ends of bridged shaped center portion 69 may respectively house a high frequency connector 15 and a termination cartridge 21.

In the depicted embodiment, LD 1 is in the form of an LD chip. A termination cartridge 21 provides a nominal electrical impedance matched to a generator used to drive LD 1. In the depicted embodiment, termination cartridge 21 provides a 50Ω termination, over a broad bandwidth (e.g. DC to several GHz). Termination tab 23 is also matched thereto, and similarly has a 50Ω impedance, over a similar bandwidth.

As further illustrated in FIG. 1A a center pin 16 connects a transmission line 17 to high frequency connector 15 in sub-mount 68. Pin 16 is mounted and fed through a first via 30 in first sidewall 29. High-frequency connector 15, may for example, be an SMA, SSMA, 3.5 mm, 2.92 mm or K connector, and makes contact with the other end of center pin 16. Solder may be applied through soldering hole 31 to fix connector 15 in position. Characteristics of example connectors, suitable for use as connector 15 are summarized in TABLE 1:

TABLE 1
Commercially available high frequency connector

| Type | Frequency Range(GHz) |
|---|---|
| SMA | DC - 18 GHz |
| SSMA | DC - 27 GHz |
| 3.5 mm | DC - 34 GHz |
| 2.92 mm | DC - 40 GHz |
| K | DC - 40 GHz |

Transmission line 17 includes a flat end and a taper end 19 that is soldered onto bridged shaped center portion 69 near first sidewall 29. Signal line 18 of transmission line 17 is physically connected to center pin 16 and extends to taper end 19 of transmission line 17, providing an interconnect to a first electrode of LD 1. The contact between center pin 16 and signal line 18 of transmission line 17 is enhanced by solder. Transmission line 17 may be thin-film micro-strip line made, for example, of alumina or aluminum nitride ceramic substrate. Signal line 18 may be formed on top surface of transmission line 17. A conducting ground-plane, formed for example of gold, may be formed on the bottom surface of transmission line 17. As noted, transmission line 17 is matched to termination cartridge 21, providing a 50Ω impedance at operating frequencies from DC to several GHz.

An isolation stand-off 25, which may be made of aluminum nitride, alumina, beryllium oxide or other type of ceramic, or other insulator is soldered or affixed onto bridge shaped center portion 69 near second sidewall 32. Isolation stand-off 25 isolates termination tab 23 from sub-mount 68, preventing a short circuit, and further acts as a spacer to fill the gap between termination tab 23 and the bridge in center portion 69 of sub-mount 68.

A termination tab 23 is fed from the second electrode of LD 1 through a second via 33, to connect a second electrode of LD 1 to termination cartridge 21, which again, provide a matching impedance of 50Ω at operating frequencies from DC to several GHz. Termination cartridge 21 is soldered to fix its position. The solder which has good electrical conductivity, may be applied through second soldering hole 34 to provide a good electrical contact between termination cartridge 21 and second via 33. Termination cartridge 21 is typically grounded in operation, providing a path from LD 1 to ground. Termination cartridge 21 may be formed as a chip resistor, a thin film resistor, or another resistor or impedance, providing the desired terminating impedance over the operating frequencies. Termination cartridge 21 operates as a damping resistor to reduce impedance mismatching between laser assembly 100, and a typical high frequency generator.

LD 1 may be soldered within the gap 70 on the bridge shaped center portion 69. LD 1 may be a multiple quantum well (MQW) InGaN/GaN semiconductor laser with a Fabry-Perot (FP) configuration or a MQW semiconductor laser having a distributed feed-back (DFB) configuration. Another type of FP LD or DFB LD, such as InGaAsP/InP, InGaAsP/GaAs, AlGaInP or AlGaAs may be replaced for the InGaN/GaN LD. TABLE 2 shows typically available LDs that may be used as LD 1.

TABLE 2
Commercially available laser diodes

| LD | Wavelength (nm) |
|---|---|
| InGaN/GaN or AlGaN/n-GaN | 370-380, 400-415, |
| (MQW InGaN/GaN on GaN substrate) | 440-450 or 468-478 |
| AlGaInP/n-GaAs | 630-690 |
| (MQW-GaInP/AlGaInP on GaAs substrate) | |
| AlGaAs/n-GaAs | 780-860 |
| (MQW-AlGaAs/GaAs on GaAs substrate) | |
| InGaAsP/n-InP | 1300 and 1550 |
| (MQW InGaAsP/InP on InP substrate) | |

A short (e.g. 1.0 mm or less) bonding ribbon may connect signal line 18 of transmission line 17 and a first electrode of LD 1. Bonding may be performed by a wedge bonding machine. Further ribbon bonding may be performed between a second electrode of LD 1 and the 50Ω termination taper tab 23.

In operation, the laser beam, emitted from the active layer of LD 1, may be divergent due to the relatively small, typically rectangular aperture of LD 1.

Light output by LD 1 may be focused or coupled by an optical coupler. To this end, an optical coupler in the form of gradient index (GRIN) lens 27 is in optical communication with the optical output of LD 1. GRIN lens 27 may be mounted on a housing 36 and aligned at the front facet of LD 1 to couple the emitted beam, with high coupling efficiency and good beam profile. Housing 36 may be formed of metal, or any other suitable material. Both surfaces of GRIN lens 27 may be coated with anti-reflection (AR) coating 28 to reduce the reflectivity and further reduce the optical feedback toward LD 1. The laser beam after GRIN lens 27 can be a collimating beam or focusing beam based on application requirement.

To allow two-facet-output, center portion of profiled sub-mount 68 is bridge-shaped, and two GRIN lenses such as GRIN lens 27, and GRIN lens 27′ having an AR coating may be mounted at front and rear facet of LD 1, as for example shown in lase module 105, depicted in FIG. 1B. The output can be collimating or a focusing beam. The two lenses may be identical GRIN lenses. Alternatively, any two lenses (including those described below), that are different or the same, may be mounted on either side of LD 1.

Further, a photo-diode (PD) 8, which has surface-receiving configuration may be soldered in a pocket 35 of profiled sub-mount 68. The laser beam emitted from the rear facet of LD 1 has a small angle with the normal axis of the PD 8 to prevent optical feedback to LD 1.

Laser modules 100, 105 may be assembled with various types of lead-free solders. Commercially available lead-free low melting temperature solders are used as listed in TABLE 3.

TABLE 3
Commercially available low temperature lead-free solders

| | | Melting Point/Liquidus |
|---|---|---|
| Solder | Composition | Temperature (° C.) |
| AuSn | 80Au20Sn | 280 |
| SnAg | 96.5Sn3.5Ag | 221 |
| SnInAg | 77.2Sn20In2.8Ag | 187 |
| In | 100In | 157 |
| InAg | 97In3Ag | 143 |
| BiSn | 58Bi42Sn | 138 |
| InSn | 52In48Sn | 118 |

Example electrical circuitry for providing a driving signal to laser module 100 (or 105) is shown in FIG. 3. Termination cartridge 21 is formed in series with LD 1 (post-LD series resistor), downstream of LD 1 (and electrical connector 15). An external driving generator 90, either a RF sinusoidal signal or a repetitive electrical pulse, has a nominal impedance of 50%, drives LD 1, through connector 15 (FIG. 1A). The post-LD signal is terminated at the 50Ω broad-bandwidth matching impedance termination cartridge 21. As a result, excess energy of the signal traveling towards the end of the transmission line may be dissipated by the termination cartridge 21, rather than being reflected back to LD 1 or generator 90. Generator 90 may, for example, be a microwave synthesizer operable over a range of frequencies (e.g. up to several GHz), or could be a single frequency generator operable in the GHz or other frequency range.

PD 8 (FIG. 1A) may also be used for monitoring. PD 8 may monitor the output power of LD 1, and generate a corresponding electrical signal. The electrical signal from PD 8 can be used as control signal for generator 90. For example, the electrical signal from PD 8 may be used for closed loop control of generator 90, to cause LD 1 to produce a constant power output laser signal. Laser module 100, so configured, provides a single-facet-output.

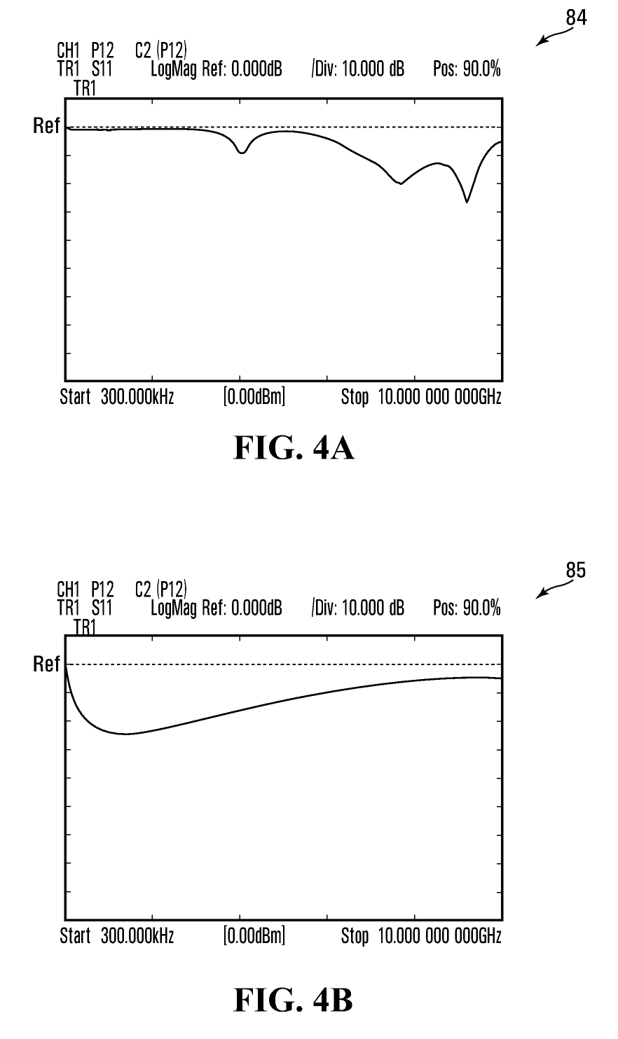

Conveniently, high frequency performance of laser module 100 is improved as compared to the conventional TO-CAN packaging. FIG. 4A depicts an S11 curve of conventional TO-CAN packaging driven with 50Ω impedance. The S11 curve of laser module 100 has enhancement at high frequency response, as shown in FIG. 4B.

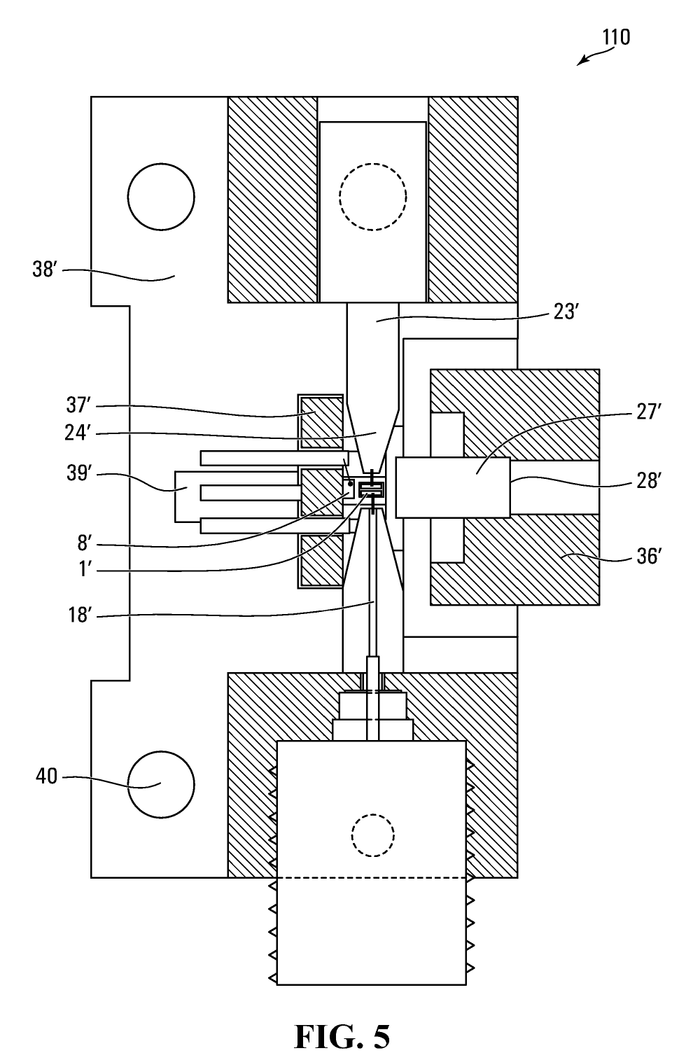

FIG. 5 is a top cross sectional view of a laser module 110, exemplary of a third embodiment of the present invention. As illustrated, laser module 110 includes a sub-mount 168, similar to sub-mount 68, but adapted to receive a conventional TO-CAN package, modified as described below.

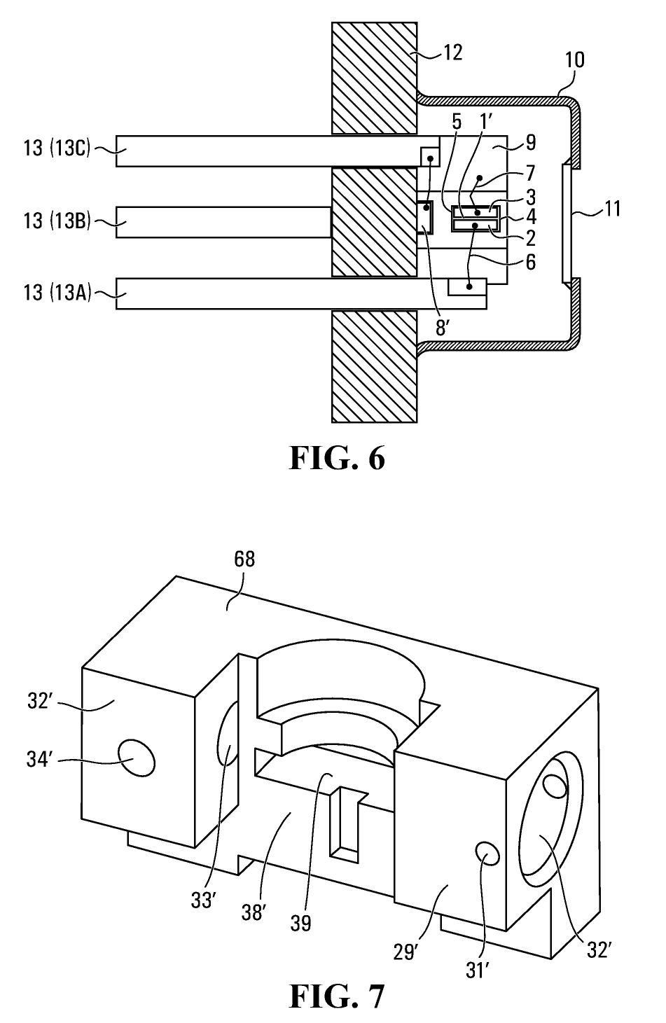

More specifically, the tubular cap 10 of a commercial TO-CAN package LD 37 may be removed as depicted in FIG. 6. Wire bonding 6, 7 is also removed while LD 1′ remains on its stem 9. A monitoring PD 8′ is attached near the rear facet of LD 1′.

Laser module 110 has, in additional to laser module 100 (FIGS. 1A, 2), slot 39 to accommodate commercial LD 37, in the form of a TO-CAN in place of LD 1, of profiled sub-mount 68. Sub-mount 168 may be used whenever bare LD 1 is unavailable or only TO-CAN packaged LD are available. However, laser module 110 provides a single-facet-output.

FIG. 7 is a cross-sectional view of sub-mount 168 before electronic and optical components are integrated or mounted thereon.

Laser module 110 is otherwise formed in the same manner as laser module 100. Like parts are thus numbered with the same numeral (with the addition of a prime (′) symbol). Their structure and interconnection may be best appreciated with reference to laser module 100.

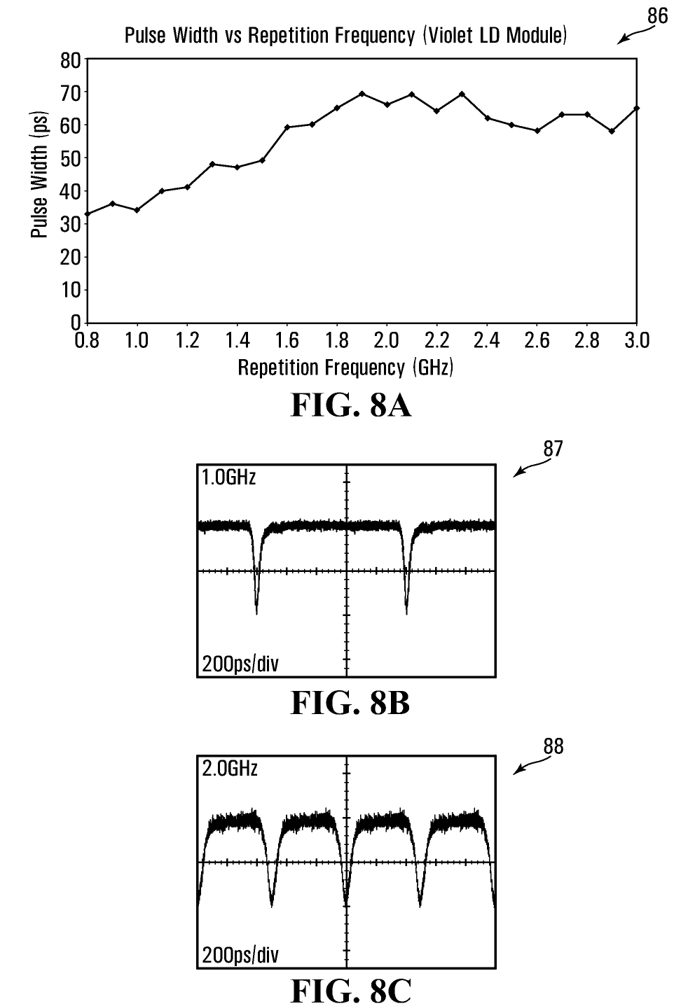

FIG. 8A shows the experimental results of an ultra-short pulse and high repetition violet semiconductor laser from 800 MHz to 3.0 GHz with the pulse width less than 70 ps 86. The pulse stream of lasers at 1 GHz 87 is shown in FIG. 8B and at 2.0 GHz 88 is shown in FIG. 8C.

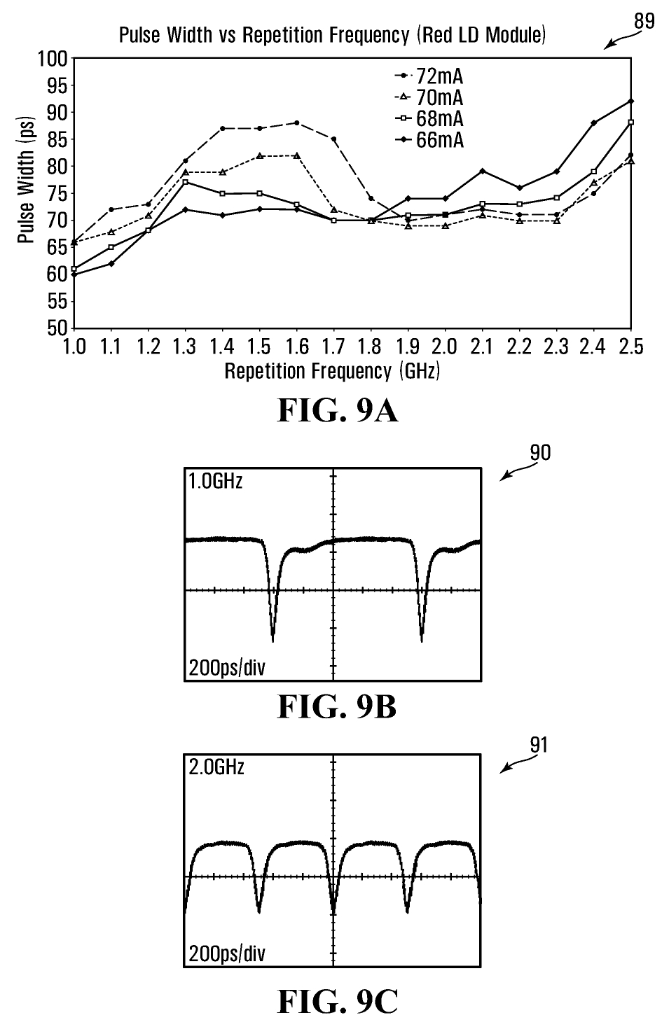

FIG. 9A shows the experimental results of an ultra-short pulse and high repetition red semiconductor laser from 1.0 GHz to 2.5 GHz with the pulse width less than 85 ps, produced by laser module 100 or 110 (FIGS. 1A, 5). The pulse stream of the laser at 1 GHz (90) is shown in FIG. 9B and at 2.0 GHz (91) is shown in FIG. 9C.

Laser module 100, 105 and 110 may be combined with a variety of optical couplers to further refine their optical output.

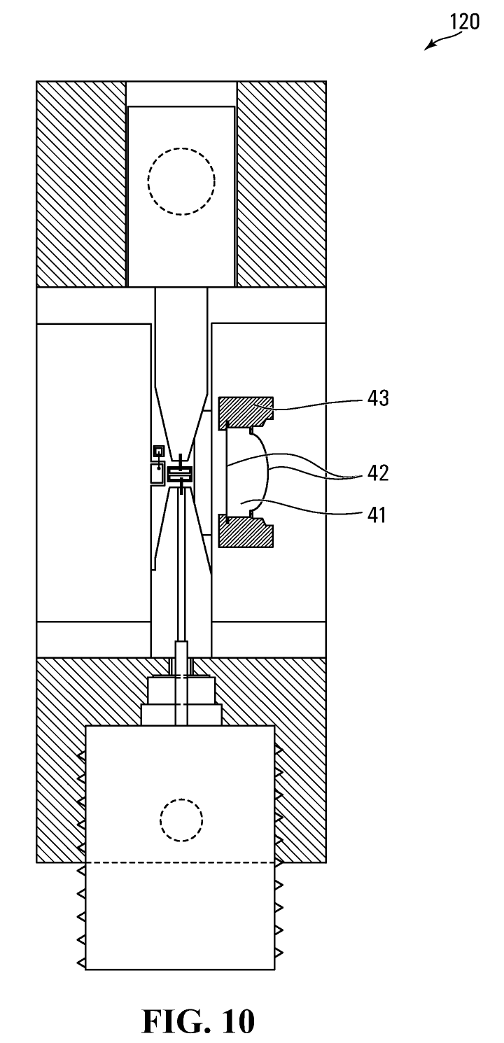

For example, FIG. 10 is a top cross sectional view of a further laser module 120, exemplary of a further embodiment of the present invention. Laser module 120 is like laser module 100, but includes aspherical lens 41 in place of GRIN lens 27. Aspherical lens 41 has an AR-coating 42, which is mounted on its housing 43 for laser coupling. The remaining components are the same as those of laser module 100. A similar AR-coated aspherical lens 41 may be used as an optical coupler in laser module 110, in place of lens 27′ or as either optical coupler in laser module 105.

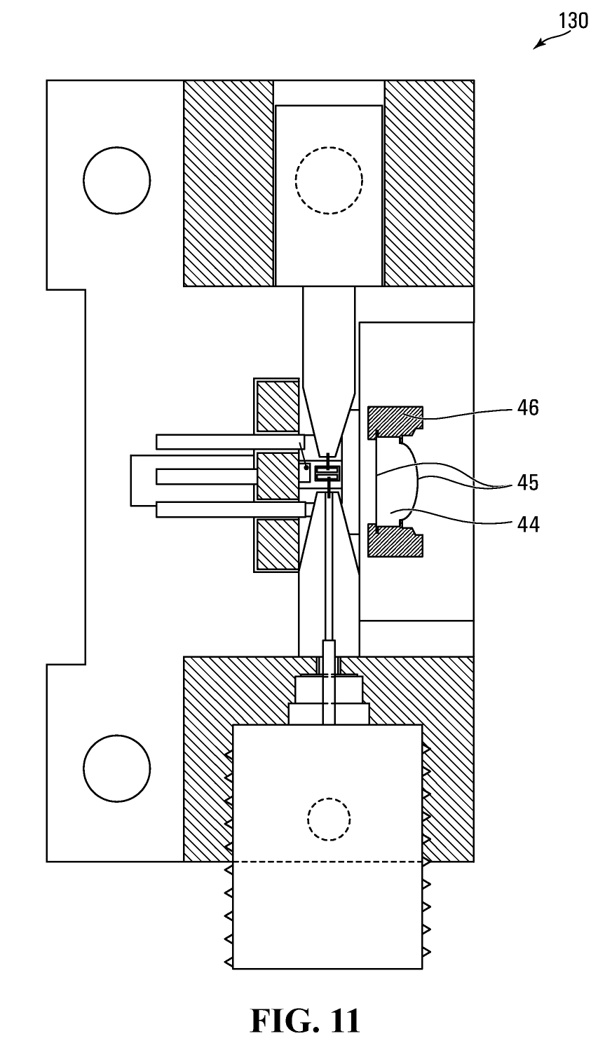

FIG. 11 is a top cross sectional view of laser module 130, exemplary of yet another embodiment of the present invention. Laser module 130 is like laser module 110 but includes a spherical lens 44 having AR-coated 45, mounted in its housing 46 for laser coupling. In additional, the AR-coated spherical lens 44 may be used as an optical coupler in laser module 100, in place of lens 27 or as either optical coupler in laser module 105.

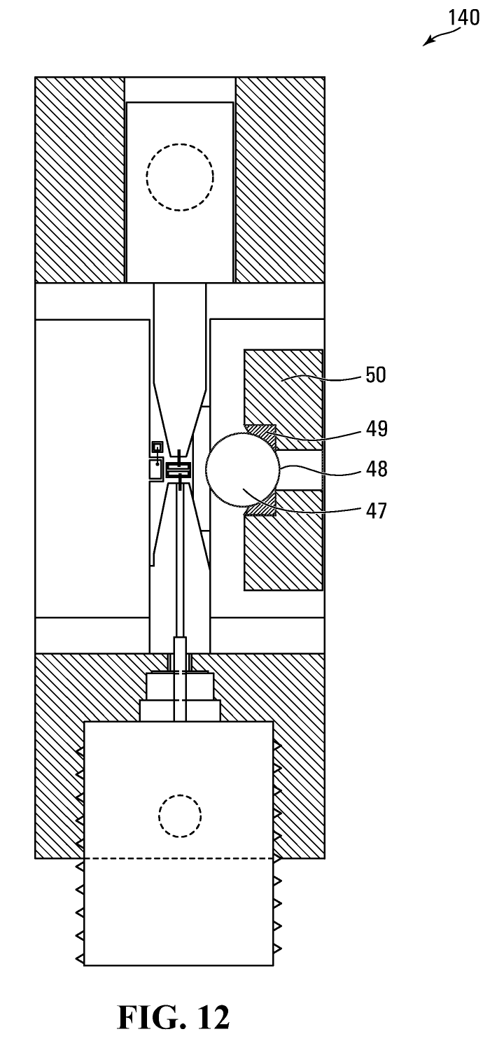

FIG. 12 is a top cross sectional view of a laser module 140, similar to laser module 100. Laser module 140 includes a ball lens 48 that has an AR-coat 47. Ball lens is mounted in sub-mount 68 in its housing 50 for laser coupling. In additional, the AR-coated ball lens 48 may be used an optical coupler in laser module 110 or as either optical coupler in laser module 105.

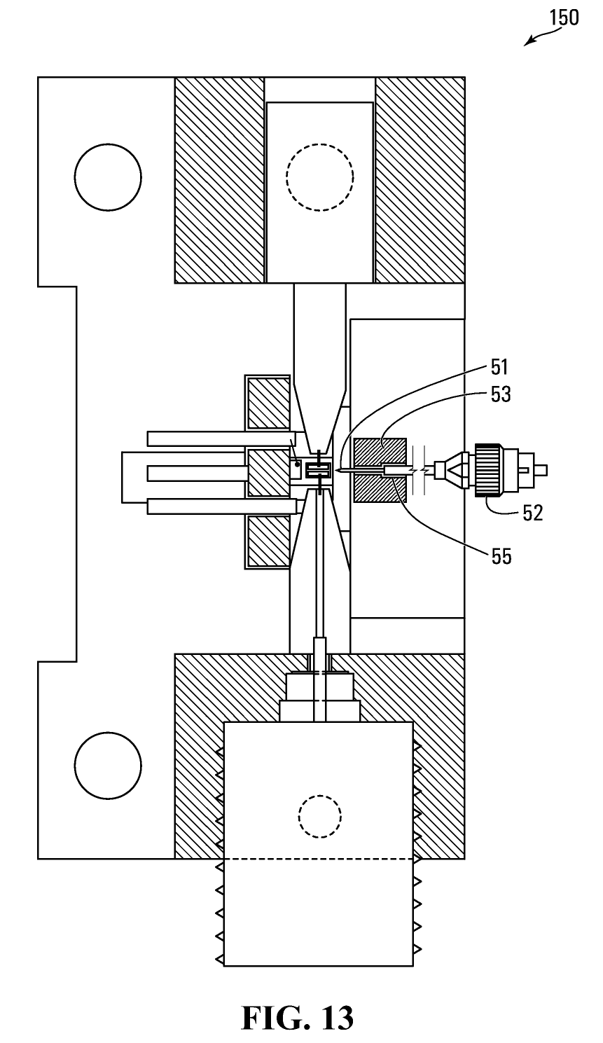

FIG. 13 is a top cross sectional view of laser module 150, similar to laser module 110. Laser module 150 has AR-coated/uncoated taper optical fiber 51 mounted on a housing 53 having V-grooves 55 for optically coupling LD 1′. The AR-coated/uncoated lens fiber or AR-coated/uncoated angled-butt fiber may replace the AR-coated/uncoated taper optical fiber 51. The other end of the optical fiber is either fiber pigtail or fiber connector 52 like an FC/APC connector. Of course, such optical fibers may be used as optical coupler in laser module 100, or as either optical coupler in laser module 105. TABLE 4 shows typical fiber connectors that may be used.

TABLE 4
Commercially available fiber connectors

| Type of connector | End face of fiber |
|---|---|
| E-2000 | PC or ARC |
| FC | PC or APC |
| SC | PC or APC |
| ST | PC or APC |
| SMA | Flat |

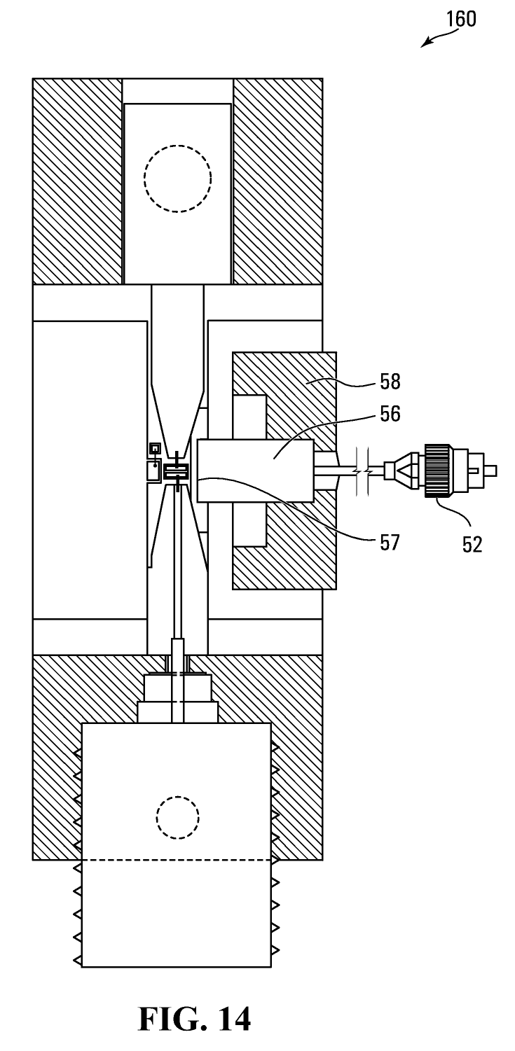

FIG. 14 is a top cross sectional view of a laser module 160. Laser module 160 is like laser module 100, but includes a collimating fiber GRIN lens 56 that has an AR-coating 57. The other end of lens 56 is either fiber pigtail or fiber connector 52 like FC/APC, mounted on its housing 59 for laser coupling. In additional, these AR-coated fiber GRIN lenses 56 may be used in place of lens 27′, in laser module 110 or in laser module 105.

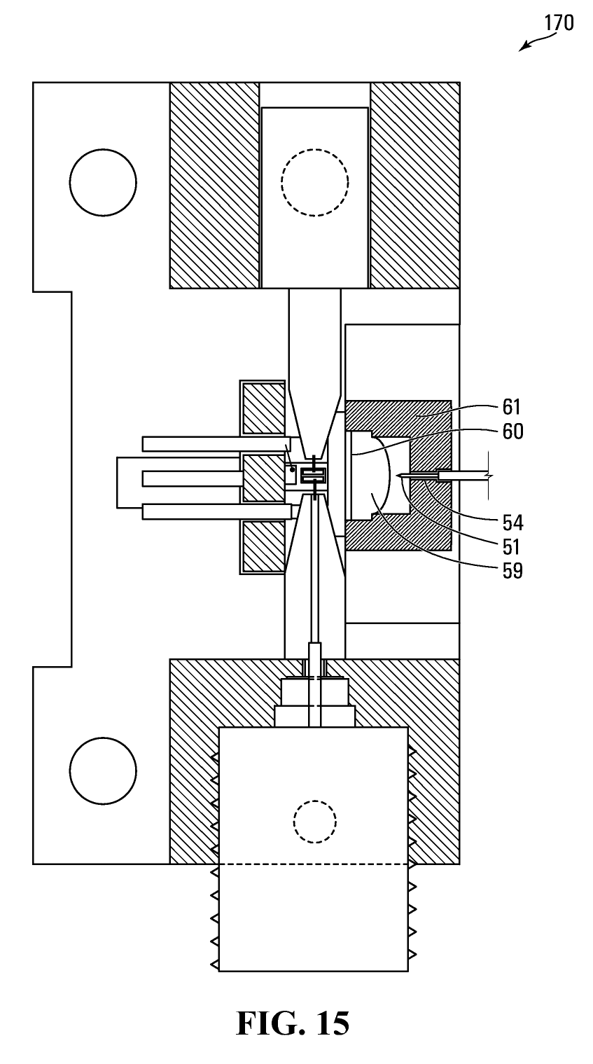

FIG. 15 is a top cross sectional view of a laser module 170. Laser module 170 includes an aspherical lens 59 having AR-coating 60 and optical fiber 51 mounted on its housing having V-grooves 54 for laser coupling. The end of the optical fiber may be AR-coated/uncoated taper fiber, AR-coated/uncoated lens fiber, AR-coated/uncoated angled-butt fiber and the other end of the optical fiber is either fiber pigtail or fiber connector like FC/APC. In additional, aspherical lens 59 may include an AR-coating 60. Again aspeherical lens 59 may be used in place of lens 27 in laser module 100 or as either optical coupler in laser module 105.

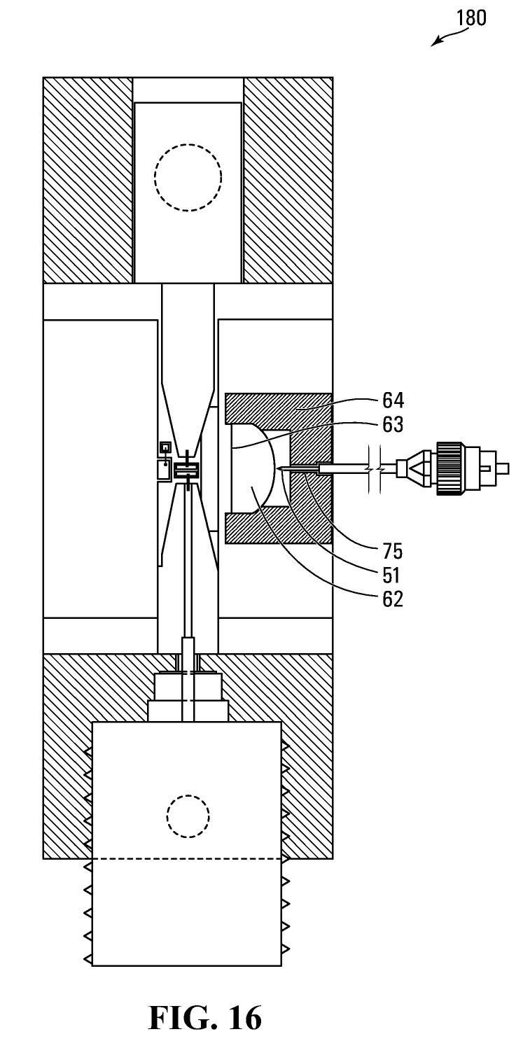

FIG. 16 is a top cross sectional view of laser module 180. Laser module 180 is like laser module 100, but includes spherical lens 62 with an AR-coated 63 and optical fiber 51 mounted on its housing having V-grooves 75 as an optical coupler. The end of the fiber may be AR-coated/uncoated taper fiber, AR-coated/uncoated lens optical fiber, AR-coated/uncoated angled-butt fiber and the other end of the optical fiber is either fiber pigtail or fiber connector like FC/APC. In additional, spherical lens 62 with an AR-coated 63 may be incorporated in laser module 110 in place of lens 27′ or in laser module 105.

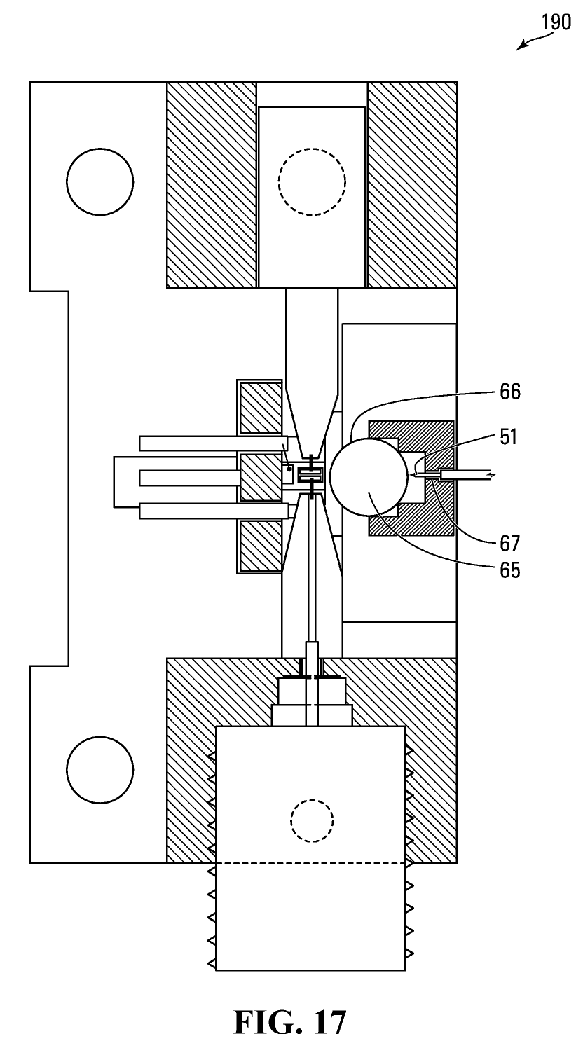

FIG. 17 is a top cross sectional view of laser module 190. Laser module 190 includes a ball lens 65 with AR-coating 66 and optical fiber 51 mounted on its housing having V-grooves 67 for laser coupling. Again, the end of the fiber may be AR-coated/uncoated taper fiber, AR-coated/uncoated lens optical fiber, AR-coated/uncoated angled-butt fiber and the other end of the optical fiber is either fiber pigtail or fiber connector like FC/APC. In additional, ball lens 65 with AR-coating 66 and optical fibers may be incorporated in laser module 100 or in laser module 105.

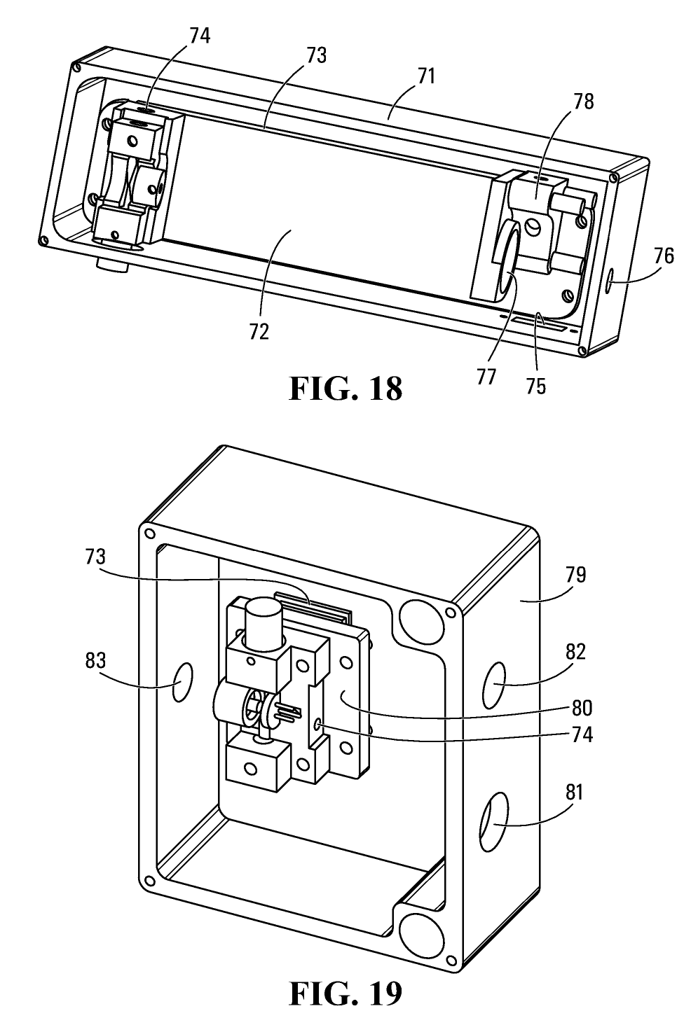

Laser modules 100, 105, 110, 120, 130, 140, 150, 160, 170, 180, and 190 may be mounted in housings 71 of FIG. 18 to form semiconductor laser head (SLH). Similarly, Laser modules 100, 110, 120, 130, 140, 150, 160, 170, 180, and 190 may be mounted in housings 71 of FIG. 19

FIG. 18 depicts a semiconductor laser head housing 71 which accommodate laser modules 100, 105, 110, 120, 130, 140, 150, 160, 170, 180, and 190. Housing 71 may further house temperature controlling devices, like thermo-electric cooler (TEC) 73 and thermistor 74, to regulate the temperature of laser module and base plate 72 at a set temperature by external temperature controller through the interface slot 75. Housing 71 accommodates either single-facet-output or both-facet-output laser modules. The collimated laser output may be shined towards optics 77 like a cavity coupler, saturable absorber, high reflection (HR)-mirror or optical grating to configure as external cavity semiconductor laser for mode-locking or tunable laser configurations. A miniaturized alignment stage 78 provides extended laser cavity alignment. An AR-coated window 76 can be at any side of the housing depending on the external laser cavity design. Alternatively, window 76 could be replaced with another suitable optical output, formed for example of one or more optical fibers. Where casing 71 is used with laser module 105 (FIG. 1B), having two lenses/optical outputs, the output of one lens could be used as a laser output, while the other could be used as an intra-cavity output.

FIG. 19 is a second example of a housing 79 which accommodate laser modules 100, 105, 110, 120, 130, 140, 150, 160, 170, 180, and 190. Similar to housing 71 (FIG. 18), housing 79 may house temperature controlling devices 73′, 74′ (like TEC 73 and thermistor 74) and connected to external temperature controller through an interface hole 81. This design accommodates single-facet-output laser modules. An AR-coated window 83 is located at the output facet of the laser module. Again, window 83 could be replaced with another suitable optical output, formed for example of one or more optical fibers.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A laser module, comprising:
an electrical connector;
a laser diode coupled to said electrical connector through a transmission line;
a matching impedance connected in series with said laser diode for providing an electrical impedance matched to a signal generator for driving said laser diode;
an optical coupler in optical communication with an optical output of the laser diode.

2. The laser module of claim 1, wherein said electrical connector, said laser diode, said transmission line, said matching impedance and said optical coupler are assembled in a sub-mount substantially formed of metal.

3. The laser module of claim 2, wherein said sub-mount comprises at least one of gold plating, copper and aluminum.

4. The laser module of claim 1, wherein said matching impedance is connected in series with said laser diode, downstream of said laser diode and said electrical connector

5. The laser module of claim 1, further comprising:
a photodiode adjacent a rear facet of said laser diode.

6. The laser module of claim 1, wherein said transmission line comprises a micro-strip transmission line comprising a signal line on its top surface, and a ground substrate on its bottom surface.

7. The laser module of claim 1, wherein a signal line of said transmission line is interconnected to said laser diode by a bonding ribbon.

8. The laser module of claim 1, wherein said matching impedance comprises a resistor.

9. The laser module of claim 1, wherein said matching impedance provides a substantially constant impedance over the operating frequencies of said generator.

10. The laser module of claim 1, wherein said laser diode provides a dual facet output.

11. The laser module of claim 7, wherein said bonding ribbon connects a first electrode of said laser diode, and wherein a second electrode of said laser diode is connected to said matching impedance by a second bonding ribbon.

12. The laser module of claim 1, wherein said optical coupler comprises an AR-coated grade-index lens (GRIN).

13. The laser module of claim 1, wherein said optical coupler comprises an AR-coated aspherical lens.

14. The laser module of claim 1, wherein said optical coupler comprises an AR-coated spherical lens.

15. The laser module of claim 1, wherein said optical coupler is an AR-coated ball lens.

16. The laser module of claim 1, wherein said optical coupler comprises a combination of AR-coated GRIN lens and an optical fiber.

17. The laser module of claim 1, wherein said optical coupler comprises a combination of AR-coated aspherical lens and an optical fiber.

18. The laser module of claim 1, wherein said optical coupler comprises a combination of AR-coated spherical lens and an optical fiber.

19. The laser module of claim 1, wherein said optical coupler comprises a combination of AR-coated ball lens and an optical fiber.

20. The laser module of claim 1, wherein said laser diode comprises one of an InGaN/GaN, an AlGaN/n-GaN, an AlGaInP/n-GaAs, an AlGaAs/an n-GaAs, and an InGaAsP/n-InP laser diode.

21. A laser module, comprising:
a metal sub-mount, comprising a generally bridge shaped mount;
a laser diode mounted on said generally bridge shaped mount,
an electrical connector, within said metal sub-mount;
a transmission line extending along said bridged shape mount to interconnect said electrical connector to a first electrode of said laser diode;
a conducting tab, extending from a second electrode of said laser diode, along said bridged shaped mount to a matching impedance;
a matching impedance within said metal sub-mount, connected in series with said conducting tab for providing an electrical impedance matched to a signal generator for driving said laser diode;
an optical coupler in optical communication with an optical output of the laser diode.

22. A laser head, comprising a housing and the laser module of claim 21, mounted in said housing.

23. The laser head of claim 22, wherein said housing comprises a window having an anti-reflective coating.

24. The laser head of claim 22, further comprising an optical fiber.
